(19) United States
(12) Patent Application Publication
(10) Pub. No.: US 2016/0048540 A1
(43) Pub. Date: Feb. 18, 2016

(54) DATABASE BUILDING AND DATA MATCHMAKING SOFTWARE SYSTEM AND METHOD OF USE

(71) Applicant: Job Shakers, LLC, Kansas City, MO (US)

(72) Inventors: Kelly J. Kearney, Overland Park, KS (US); Kevin L. Fryer, Kansas City, MO (US)

(21) Appl. No.: 14/820,305

(22) Filed: Aug. 6, 2015

Related U.S. Application Data
(60) Provisional application No. 62/036,954, filed on Aug. 13, 2014.

(51) Int. Cl. G06F 17/30

(52) U.S. Cl. CPC G06F 17/30292; G06F 17/30312

(57) ABSTRACT

A software application for matching a first data category with one or more additional data categories. The system provides two or more columns which can be individually scrolled through to allow for matching of data elements in one column with data elements in another column. In a preferred embodiment, the first column of data is generated from contacts located on the user's mobile computing device, such as a smart phone. Data in other columns is pulled from remotely located databases. A primary use for such a matchmaking system would be for job referrals by users connecting the unique contacts stored locally on their mobile devices to job openings stored with a remotely located database.

### CROSS-REFERENCE TO RELATED APPLICATION

This application claims priority in U.S. Provisional Patent Application No. 62/036,954, filed Aug. 13, 2014, which is incorporated herein by reference.

### BACKGROUND OF THE INVENTION

1. Field of the Invention

The present invention relates generally to a matchmaking system and method implemented by a computer, and more specifically to a computer implemented software system and method of use for creating a matchmaking correlation between two or more lists of items, including individual contacts.

2. Description of the Related Art

Existing software applications provide computer-aided means of searching through databases and generally correlating data points with other data points. However, existing systems do not adequately pair data located at remote locations with data located locally on the user's computing device, such as contacts on a smart phone. What is needed is a software application which allows a user to quickly match contacts or other data stored on their personal computing devices with categories or data classifications based upon remotely stored databases.

Heretofore there has not been available a system or method for matchmaking with the advantages and features of the present invention.

### SUMMARY OF THE INVENTION

The present invention generally provides a software application for matching a first data category with one or more additional data categories. The system provides two or more columns which can be individually scrolled through to allow for matching of data elements in one column with data elements in another column. In a preferred embodiment, the first column of data is generated from contacts located on the user's mobile computing device, such as a smart phone. Data in other columns is pulled from remotely located databases.

This system is primarily useful for creating a job-matching system for matching individual contacts with a database of job listings. Other uses include dating, services (e.g., contracting or consulting), social networking, shopping, or any other foreseeable need to match a contact with another data variable.

This invention creates unique data-matching results by matching a local database on a mobile computing device (e.g., database of personal contacts on a smart phone device) with an external database (e.g., a published list of job offerings) to result in a unique combination of data matching which could not occur without the present invention.

### BRIEF DESCRIPTION OF THE DRAWINGS

The drawings constitute a part of this specification and include exemplary embodiments of the present invention illustrating various objects and features thereof.

FIG. 1 is a diagrammatic representation of several of the elements present in a preferred embodiment of the present invention.

FIG. 2 is a diagrammatic representation of several more of the elements present in a preferred embodiment of the present invention.

FIG. 3 is a diagrammatic representation of an example user interface (UI) associated with a preferred embodiment of the present invention.

FIG. 4 is a diagrammatic representation of another example user interface (UI) associated with a preferred embodiment of the present invention.

FIG. 5A is a diagrammatic representation of the user interface of FIG. 3 being interacted with by a user.

FIG. 5B is a diagrammatic representation of the user interface of FIG. 3 being interacted with by a user.

FIG. 6 is a flowchart diagramming the steps required to practice a preferred embodiment of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices.

### II. Preferred Embodiment Database Building and Data Matching Software System 2

The primary purpose of the present invention is to provide a matchmaking software application for matching contacts stored on a user's smart device with data elements located in a second database, which preferably will be remotely located.

A user will activate the software application, which will import their contacts stored locally on their smart device into the application. The software will then load additional lists of data points from other databases which may be remotely located. The user may then select one or more contacts in the first list by tapping a touchscreen interface or otherwise interacting with a user interface, and then the user will select one or more items from the other lists of items. The user then selects to have these datapoints matched, generating a digital handshake. The contact will then be sent information pertaining to the data element selected in the second column (e.g., a job listing) and then may pursue or ignore the request from that point on.

Other interactions with the user interface may include the general “swiping” motion across the screen once the contact list is aligned with another list, thereby pairing the contact with the data element in the second list.

In an expanded view, contacts may indicate their status which will be sent to their contacts and friends such that when the software application is accessed, the contacts list features color-coded contacts based upon each contact's preference. For example, contacts could be color coded differently if they are looking to be matched, not looking to be matched, or open to being matched but not specifically looking This could be especially useful in dating or job-search fields.

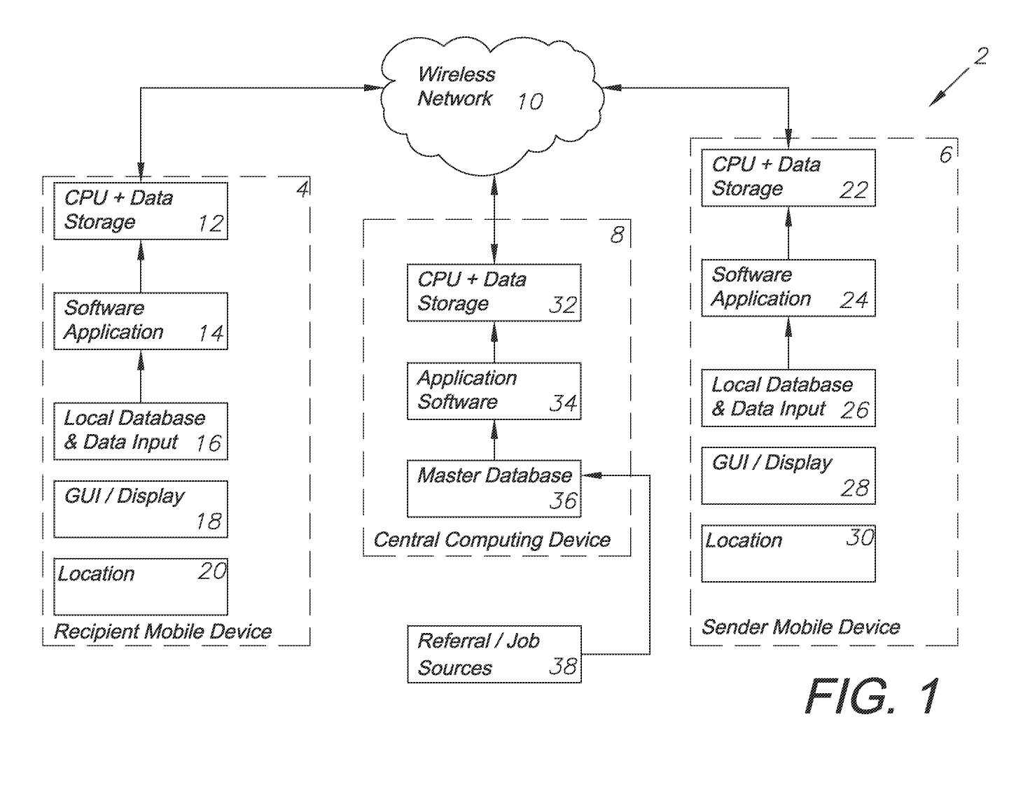

Referring to the figures in more detail, FIG. 1 shows a diagrammatic representation of several elements of a database building and data matchmaking software system 2 (“software system”) which generally connects at least one recipient mobile computing device 4 (“recipient”), a sender mobile computing device 6 (“sender”), and a centralized computing device 8 (“central server”) over a wireless network 10. A fourth entity referral source 38 (“source”) feeds data into the master database 36 stored on the central server 8, which forms the basis for the present invention.

The recipient mobile device 4 includes a CPU and general data storage 12, a software application 14 for at least receiving messages, a local database with localized data inputs 16, a graphical user interface (GUI) 18, and is associated with a location 20 which may serve to determine results that would be sent to the recipient.

The sender mobile device 6 includes a separate CPU and data storage 22, a software application 24 associated with the present invention which is capable of matching a local database 26 with a remotely located master database 36, a GUI 28, and is associated with a location 30 which may serve to determine results that the software application receives from the central server 8.

The central server 8 includes a CPU and data storage 32, application software 34 for sending, receiving, organizing, and analyzing data in the master database 36 or otherwise received from senders, recipients, and referral sources 38. The referral source 38 is typically the source of the data placed into the master database 36. In a preferred example, the referral source 38 is an employer with job listings which is will place into the master database 36. The sender 6 would be an employee of the referral source, and would receive the job listings in the master database by accessing the software application 24 on the sender's mobile device, and can then match contacts stored in the sender's local database 26 with the jobs in the master database 36. Those contacts which the sender connects with job listings become recipients and receive a message with information about the job listing(s) via the mobile device software application 14 which may be as simple as text messaging or email software.

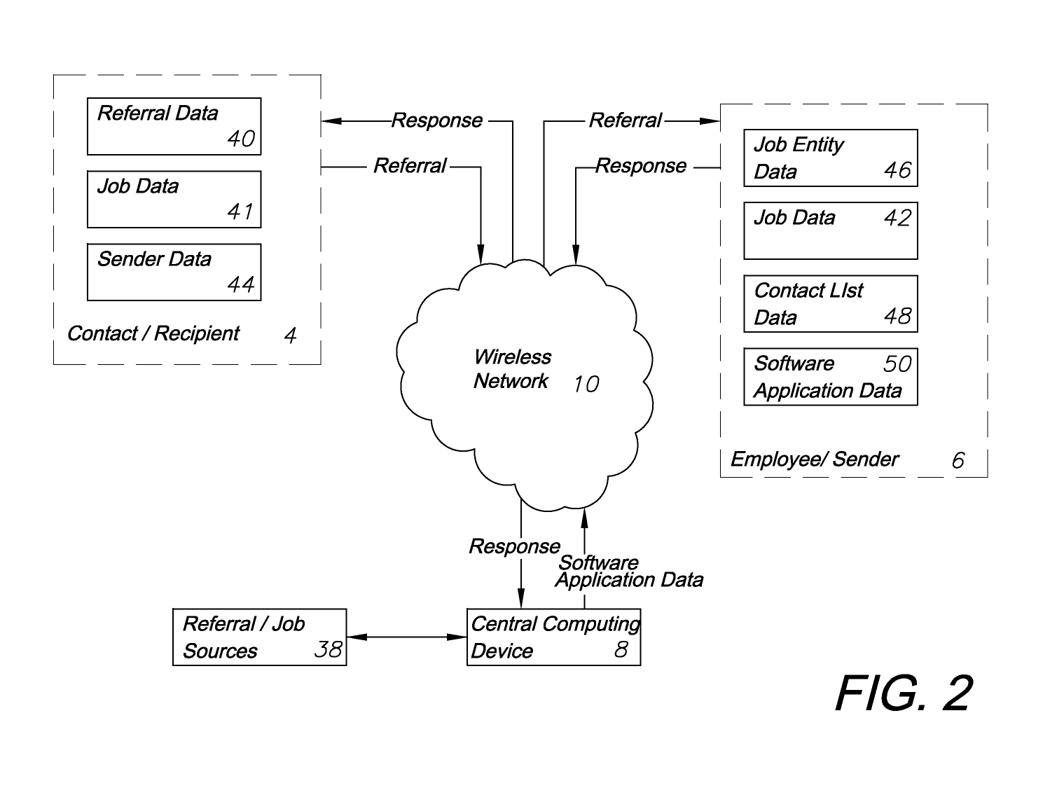

FIG. 2 shows a slightly different organization of the present invention, wherein the recipient 4, the sender 6, and the central computing device 8 all exchange information comprising different types of data through the wireless network 10. Similarly, the referral source 38 is providing job listing data directly to the central computing device 8, which may also be done over the same or a different wireless network, or a wired network, or any other suitable means of communication. The preferred method would be through a website portal which is secured and personalized for the referral source 38, and which the referral source may update at any time.

Generally, the recipient 4 is receiving referral data 40 and sender data 44 from sender(s) 6, and possesses job data 41 which corresponds to the recipient's current form of employment. Note that job data 41 may refer to any personal data relevant to the matchmaking system's ultimate function, such as relationship status for a personal matchmaking service, or any other conceivable data matching requirement.

The sender 6 receives job data 42 from the central computing device and sends that information to the recipient. The sender is associated with job entity data 46 which indicates that the sender is somehow related to the referral source 38. The sender also possesses a unique and locally stored contact list full of contact list data 48, which is important to forming the unique data matching connections associated with the present invention. Software application data 50 of the sender 6 may include any other relevant information, such as the geographic location of the sender or other performance data associated with the match making software.

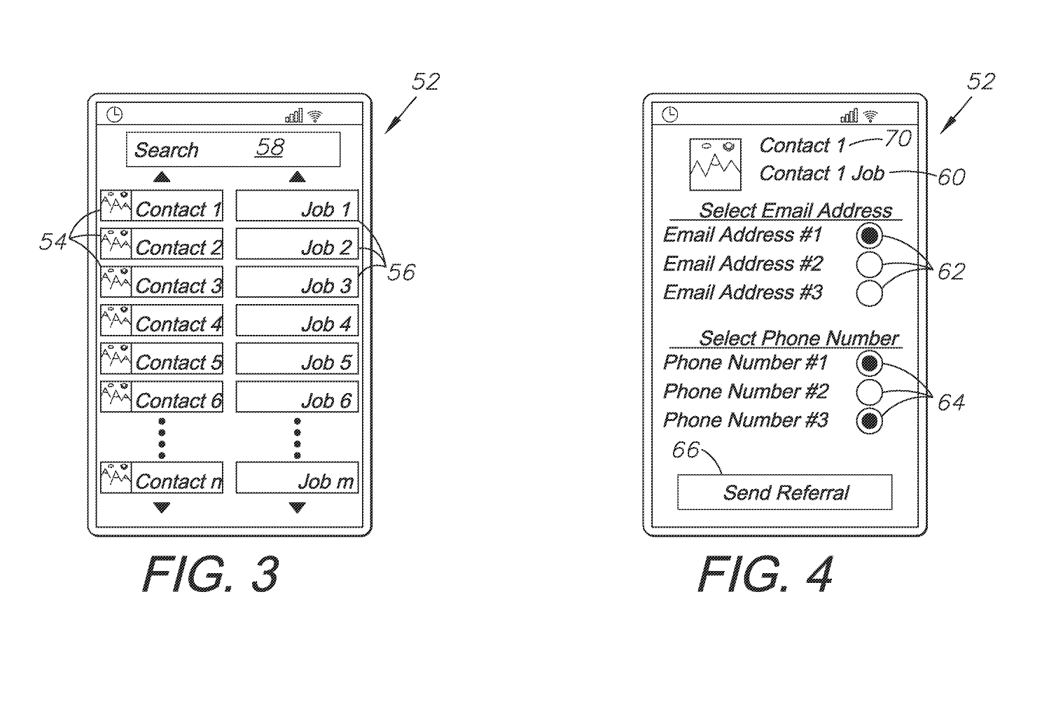

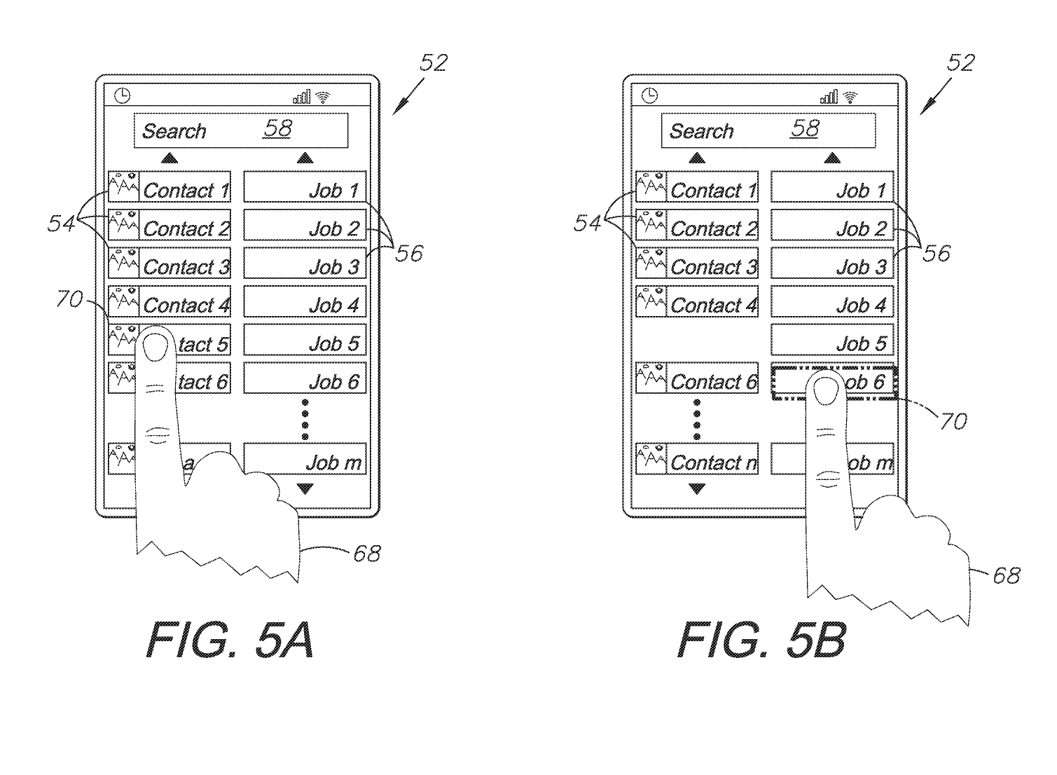

FIG. 3 is a representation of a sample GUI 52 of a sender's mobile device. In this example, a list of contacts 54 is located in a column on the left, and a list of job positions 56 is located in a column on the right. The job positions 56 are obtained directly from the master database 36, whereas the contacts are obtained solely from the local database 26 of the sender's mobile device. Each of the two columns are separately scrollable or searchable. The search bar 58 allows the sender to search for a specific contact or a specific job posting quickly. FIGS. 5A and 5B go into further detail, showing how a contact is selected by the user 68. That contact becomes the selected contact 70, and graphically is lifted from its position in the list. The user can slide the selected contact 70 across from the left column to a job on the right column as shown in FIG. 5B.

When these steps are done, the sender must choose how to send the notification to the recipient. FIG. 4 shows a sample representation of an information screen including the selected contact 70, the selected contact's current status 60, such as current job, all known email addresses 62 and all known phone numbers 64. The email addresses and phone numbers are pulled directly from the sender's local database 26 of contacts. Any and all other forms of contact may also be individually selected (e.g., social network such as Facebook®, text message, or through the software application itself). The matchmaking request will be sent to the recipient only through those methods of communication selected by the sender on this particular interface.

Once this is done, the sender selects the “send referral” button 66 which sends the referral off to the recipient. The recipient will receive a link to a website portal which has the information about the referral, e.g., a job listing, and the recipient can select to accept or deny the referral. This information may or may not be sent back to the sender and/or the referral source. If the recipient chooses to accept the referral, the recipient will provide relevant details about themselves through the website portal or other software application, such as their résumé and other relevant details. This data will go to the referral source, who may decide the next steps regarding the recipient.

The central computing device 8 will analyze referral data and may allocate scores or grades on sender's abilities to elicit acceptances from their contacts. These scores may be further enhanced based on whether or not the referral source ultimately selects the recipient for the position. Sender's performance scores may then be used for benefits or other incentives from the referral source. This in turn will entice the sender to attempt more matches using the present invention.

The central computing device 8 will further analyze the job data, recipient data, and other relevant data to track trends in the marketplace for job creation or other relevant details. This information could have great use for determining fields of high demand or fields lacking in qualified worker placement in a job placement example.

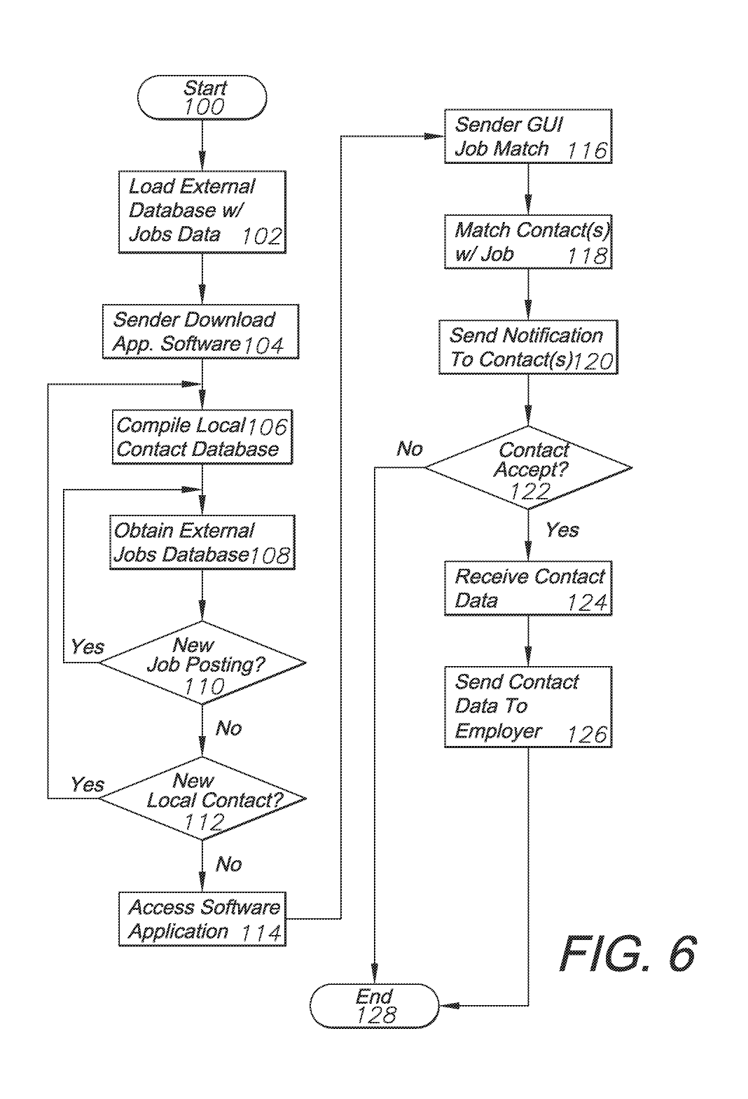

FIG. 6 shows an example method of using the present invention for a job listing match making process. The example starts at step 100, and the external master database is loaded with job listing data from the referral source 38 at step 102. The sender downloads the application software 24 to their mobile device 6 at step 104. The software accesses the sender's local database of contacts and compiles that database at 106 for use with the matchmaking software. The software then accesses the remotely located master database at step 108. At this point the sender may access the software and see the list of contacts next to the list of jobs (or other relevant data) as shown in FIG. 3.

The system checks the master database for new job postings at 110. If there are new job postings, the software application obtains the external database again at 108, including updated job postings (or job removals). If there are no changes to the master database, the system then checks the sender's mobile computing device for new or altered contacts at 112. If contact data has changed or otherwise been updated, the database is compiled again at 106.

The sender accesses the software application 24 on their mobile device 8 at step 114. The software loads the appropriate matchmaking interface to the sender's GUI at 116. The sender then scrolls through the list of contacts and job postings and matches contacts with job postings at 118. The system automatically sends notifications to the contacts at 120. The contacts have the opportunity to accept the contact at 122. If the contact does not accept the request, the process ends at 128, and the system will perform appropriate analysis and updates as discussed above.

If the contact does accept the request at 122, then they receive the appropriate data for the job posting at 124. The contact will input the appropriate contact data (e.g., résumé) and will send that information to the employer/referral source at 126. This particular process then ends at 128, but the employer will likely perform additional analysis regarding the contact's data outside of this matchmaking system.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A computer implemented method of generating a database of matched data sets, the method comprising the steps:
registering a matchmaker with a data matching system, said data matching system comprising a central computer comprising a CPU and data storage storing a central database containing a central data set, and is connected to a wireless computer network; and said matchmaker associated with a first computing device comprising a CPU, data storage, and GUI, and wherein said first computing device is connected to said wireless computer network, and wherein said first computing device is portable;
sending at least a portion of said central data set to said first computing device via said wireless computer network;
displaying on said first computing device GUI a first column containing a list comprising a local data set taken from a database stored within said first computing device data storage, and a second column containing a list comprising said central data set, and wherein said first column and second column are independently scrollable;
matching with said GUI an element from said local data set with an element from said central data set;
sending a notification to a second computing device, said second computing device comprising a CPU, data storage, and GUI, and wherein said second computing device is connected to said wireless computer network, and wherein said second computing device is portable;
accepting said notification with said second computing device; and
sending a personal data set from said second computing device to a third computing device, said third computing device comprising a CPU, data storage, and GUI, and wherein said third computing device is connected to said wireless computer network, and wherein said personal data set is stored locally on said third computing device data storage.

2. The computer implemented method of claim 1, wherein said central data set comprises a list of open job positions, wherein said local data set comprises a list of contacts, and wherein said personal data set comprises a résumé.

3. The computer implemented method of claim 2, wherein said first computing device is associated with an employee of an employer associated with said third computing device, and said second computing device is associated with a contact included within said local data set.

4. The computer implemented method of claim 1, further comprising the step:
dragging one element from said first column to one element from said second column using said GUI of said first computing device.

5. The computer implemented method of claim 1, further comprising the steps:
associating said notification with said first computing device;
recording said notification within a performance data set stored within said central computing device database; and
generating an evaluation of said notification with said third computing device based upon said personal data set received from said second computing device.

6. The computer implemented method of claim 5, further comprising the steps:
storing said evaluation within said performance data set; and
sending said evaluation to said first computing device.

7. The computer implemented method of claim 1, wherein said central data set comprises a list of open job positions, wherein said local data set comprises a list of contacts, and wherein said personal data set comprises a résumé.

8. The computer implemented method of claim 2, wherein said first computing device is associated with an employee of an employer associated with said third computing device, and said second computing device is associated with a contact included within said local data set.

9. A matchmaking system comprising:
a computer network allowing wireless communication among a plurality of computing devices through wireless communications;
a first computing device including a CPU, data storage, a graphical user interface (GUI), and a GNSS antenna and receiver, said first computing device being connected to said computer network;
a local data set stored within said first computing device data storage;
a second computing device including a CPU, data storage, a graphical user interface (GUI), and a GNSS antenna and receiver, said second computing device being connected to said computer network;
a personal data set stored within said second computing device data storage;
a third computing device including a CPU, data storage, a graphical user interface (GUI), said third computing device being connected to said computer network;
a remote server having a CPU and data storage containing a central database, said server being connected to said computer network;
a central data set stored within said central database of said remote server data storage;
said first computing device GUI configured to display a first column and a second column simultaneously, each of said first and second columns being independently scrollable;
said first column comprising elements of said local data set;
said second column comprising elements of said central data set;
a match set comprising an element of said first column matched with an element of said second column via said GUI, wherein said second computing device is associated with said element of said first column;
a notification sent to said second computing device via said wireless network; and
data from said personal data set sent from said second computing device to said third computing device via said wireless network.

10. The system of claim 9, wherein said central data set comprises a list of open job positions, wherein said local data set comprises a list of contacts, and wherein said personal data set comprises a résumé.

11. The system of claim 10, wherein said first computing device is associated with an employee of an employer associated with said third computing device, and said second computing device is associated with a contact included within said local data set.

12. The system of claim 9, further comprising:
a software-based user interface stored on said first computing device data storage and accessible via said first computing device GUI; and
wherein said match set is generated by dragging said element of said first column over to said element of said second column within said software-based user interface.

13. The system of claim 9, further comprising:
a performance data set stored within said remote server central database;
an evaluation generated with said third computing device based upon said personal data set received from said second computing device; and
said evaluation stored within said performance data set.

14. The system of claim 13, wherein said central data set comprises a list of open job positions, wherein said local data set comprises a list of contacts, and wherein said personal data set comprises a résumé.

15. The system of claim 14, wherein said first computing device is associated with an employee of an employer associated with said third computing device, and said second computing device is associated with a contact included within said local data set.

16. A matchmaking system comprising:
a computer network allowing wireless communication among a plurality of computing devices through wireless communications;
a plurality of mobile computing devices, each including a CPU, data storage, a graphical user interface (GUI), and a GNSS antenna and receiver, and each said mobile computing device being connected to said computer network;
a remote server having a CPU and data storage containing a central database, said server being connected to said computer network;
each of said plurality of mobile computing devices including a respective unique local data set stored within each respective data storage;
a third party computing device including a CPU, data storage, a graphical user interface (GUI), said third party computing device being connected to said computer network;
a third party data set generated by said third party computing device and stored within said central database;
each of said plurality of mobile computing devices configured to display a first column and a second column simultaneously using their respective GUI, each of said first and second columns being independently scrollable;
said first column comprising elements of said unique local data set of a respective one of said plurality of mobile computing devices;
said second column comprising elements of said third party data set; and
at least one match set comprising one element of one said unique local data set of said respective one of said plurality of mobile computing devices and one element of said third party data set.

17. The system of claim 16, further comprising:
a recipient computing device including a CPU, data storage, a graphical user interface (GUI), and a GNSS antenna and receiver, and said recipient computing device being connected to said computer network;
a personal data set stored within said recipient computing device data storage;
said recipient computing device associated with said one element of one said unique local data set of said respective one of said plurality of mobile computing devices contained within said match set;
a notification sent to said second recipient computing device via said wireless network; and
data from said personal data set sent from said recipient computing device to said third party computing device via said wireless network.

18. The system of claim 17, wherein said third party data set comprises a list of open job positions, wherein each said unique local data set comprises a unique list of contacts, and wherein said personal data set comprises a résumé.

19. The system of claim 18, wherein each of said mobile computing devices is associated with an employee of an employer associated with said third party computing device, and said recipient computing device is associated with a contact included within the unique local data set of said match set.

20. The system of claim 16, further comprising:
a software-based user interface stored on said first computing device data storage and accessible via each said mobile computing device GUI; and
wherein said match set is generated by dragging said element of said first column over to said element of said second column within said software-based user interface.
